(19) United States
(12) Patent Application Publication
(10) Pub. No.: US 2024/0385446 A1
(43) Pub. Date: Nov. 21, 2024

(54) OPTICAL SPLITTER

(71) Applicant: TRULIFE OPTICS LIMITED, London Greater London (GB)

(72) Inventors: Sophie VIAENE, London Greater London (GB); Andrii VOLKOV, London Greater London (GB)

(73) Assignee: TRULIFE OPTICS LIMITED, London Greater London (GB)

(21) Appl. No.: 18/722,139

(22) PCT Filed: Dec. 20, 2022
(86) PCT No.: PCT/EP2022/086994

§ 371 Date: Jun. 20, 2024

(30) Foreign Application Priority Data
Dec. 22, 2021 (GB) 2118765.3

(51) Int. Cl. G02B 27/01; G02B 27/12

(52) U.S. Cl. CPC G02B 27/0172; G02B 27/123; G02B 2027/0174; G02B 2027/0178

(57) ABSTRACT

The present disclosure relates to an optical splitter for a scanning projector system such as that provided in an augmented reality system. The optical splitter includes: an input side and a spaced apart and opposing output side, the input side includes at least one input optical facet and the output side includes two or more output optical facets. The at least one input facet are arranged to receive an input optical signal from a light source, and the two or more output optical facets are arranged to output an output optical signal dependent on the input optical signal. Each of the output optical facets define an optical path and each of the optical paths have a different optical power.

### CROSS-REFERENCE TO RELATED APPLICATIONS

This application is a national stage application, filed under 35 U.S.C. § 371, of International Patent Application No. PCT/EP2022/086994, filed on Dec. 20, 2022, which claims priority to United Kingdom Patent Application No. 2118765.3, filed on Dec. 22, 2021, the entire contents of each of which is incorporated by reference herein in its entirety.

### BACKGROUND

### 1. Field of the Disclosure

The disclosure relates to an optical splitter and in particular to an optical splitter for eyebox expansion in virtual retinal display projector systems, such as augmented reality display systems.

### 2. Description of the Related Art

Augmented reality (AR) displays such as wearable (or head mounted) displays allow users to view displayed content whilst also allowing the user to view their external environment. The displayed content, which can be electronic messaging such as text messaging, directional graphics and the like, is overlaid in the view of the user's external environment. AR displays enable users to see what appears to be a conventional graphical display, in the form of a virtual image floating in the field of view in front of them. AR displays can take the form of smart glasses to enable the virtual image is displayed to a user wearing the smart glasses. Such AR display systems typically use holographic optical elements (HOEs) to direct light from a virtual retinal display projector to a user's eye and typically the HOE is provided in or on one or more lenses of the smart glasses.

In the context of augmented reality displays, and more generally near eye optical devices such as telescopes and binoculars, the concept of an eyebox is the range of eye positions over which an image provided by the device or display can be viewed by the user. This concept is well known in the field of augmented reality displays and is described, for example in U.S. Pat. No. 9,958,682 which discusses the relative merits of providing a larger eyebox by pupil replication without adding bulky and expensive optical components.

The optical splitter described in U.S. Pat. No. 9,958,682 utilises multiple facets on an output side of the optical splitter. The optical splitter in conjunction with a holographic optical element directs replicated pupils to a user's eye. The problem however with this arrangement is that the image relayed to the replicated pupils will differ in resolution from pupil to pupil. This is because the replicated pupils originate from a set of displaced virtual projector beams, which without additional optics will not be optimally focused at a user's eye.

To address this problem, it is known to use additional optics such as liquid lenses. To function correctly, a liquid lens solution requires eye tracking to dynamically adjust the optical power of the lens. The position of the user's eye pupil is detected, and the ray path to a user's eye is known to come from one of a number of virtual projector positions, and the power of the lens is adjusted accordingly to improve the resolution for the particular replicated pupil used. Eye tracking is needed to adjust the power of the liquid lens and provide a different optical power for each of the virtual projector positions generated by the optical splitter. Furthermore, liquid lenses are not optimally suited to correct for the aberrations of the projector system, because a single optical element is used to correct for aberrations for all of the replicated pupils.

### SUMMARY

With the above problems in mind there is therefore provided an optical splitter for a scanning projector system, the optical splitter comprising: an input side and a spaced apart and opposing output side, wherein the input side comprises at least one input optical facet and the output side comprises two or more output optical facets, the at least one input facet arranged to receive an input optical signal from a light source, and the two or more output optical facets arranged to output an output optical signal dependent on the input optical signal, each of the output optical facets defining an optical path and wherein each of the optical paths has a different optical power.

The two or more output optical facets each have a respective optical power and the optical power of each of the at least two or more of the respective output facets is different. The output facets are arranged as a one-dimensional array or as a two-dimensional array.

The optical power of each of the at least two or more of the respective output facets is defined by a respective radius of curvature of each of the output facets and each radius of curvature is different. The optical power of each of the at least two or more of the respective output facets is defined by a radius of curvature of each of the output facets and each of the facets have a different center of curvature. The curvature of the output facets is concave and/or convex.

The input side comprises two or more input optical facets. The two or more input optical facets each have a respective optical power and the optical power of each of the at least two or more of the input facets is different. The input facets are arranged as a one-dimensional array or a two-dimensional array. The optical power of each of the at least two or more of the respective input facets is defined by a respective radius of curvature of each of the input facets and each radius of curvature is different. The optical power of each of the at least two or more of the respective input facets is defined by a respective radius of curvature of each of the input facets and each of the facets have a different center of curvature. The optical splitter has volumetric polygonal transparent structure and each of said output optical facets have a different focal length.

There is also provided a scanning projector system for a virtual retinal display, the scanning projector system comprising: a light source to provide a light beam, a scanning mirror arranged to reflectively scan the light beam from the light source and an optical splitter according to embodiments, wherein the optical splitter is positioned in an optical path of the scanning mirror and the scanning mirror is arranged rotate between a first angular position and a second angular position. The input side of optical splitter is arranged to receive the input light beam reflectively scanned by the scanning mirror and wherein the output side of the optical splitter is arranged to output an output light beam from one of the output facets dependent on the angular position of the input light beam. The light source is an array of laser diode or light emitting diode RGB light sources.

There is further provided a wearable virtual retinal display comprising the scanning projector system and a holographic optical element, wherein the scanning projector system is arranged to project a plurality of eyeboxes onto the holographic optical element and the holographic optical element is arranged to direct said plurality of eyeboxes to an eye of a user.

Yet further there is provided a pair of augmented reality glasses comprising the virtual retinal display, wherein the holographic optical element is arranged in or on a lens of said glasses.

### BRIEF DESCRIPTION OF THE DRAWINGS

So that the manner in which the features of the present disclosure can be understood in detail, a more particular description is made with reference to embodiments, some of which are illustrated in the appended figures. It is to be noted, however, that the appended figures illustrate only typical embodiments and are therefore not to be considered limiting of its scope. The figures are for facilitating an understanding of the disclosure and thus are not necessarily drawn to scale. Advantages of the subject matter claimed will become apparent to those skilled in the art upon reading this description in conjunction with the accompanying figures, in which like reference numerals have been used to designate like elements, and in which:

FIG. 1 illustrates a schematic of an optical splitter according to embodiments utilised in a scanning projector system.

FIG. 2a illustrates a top view of an optical splitter according to an embodiment.

FIG. 2b illustrates an end view of an optical splitter according to an embodiment.

FIG. 2c illustrates a perspective view of an optical splitter according to an embodiment.

FIG. 2d illustrates a perspective view of an optical splitter according to an embodiment.

FIG. 3a illustrates a top view of an optical splitter according to an embodiment.

FIG. 3b illustrates a perspective view of an optical splitter according to an embodiment.

FIG. 3c illustrates a perspective view of an optical splitter according to an embodiment.

FIG. 4a illustrates a top view of an optical splitter according to an embodiment.

FIG. 4b illustrates a perspective view of an optical splitter according to an embodiment.

FIG. 4c illustrates a perspective view of an optical splitter according to an embodiment.

FIG. 5a illustrates a schematic of an optical splitter according to embodiments utilised in a scanning projector system.

FIG. 5b illustrates a ray diagram of an output of the scanning projector system of FIG. 5a utilising an optical splitter according to embodiments together with a holographic optical element.

### DETAILED DESCRIPTION

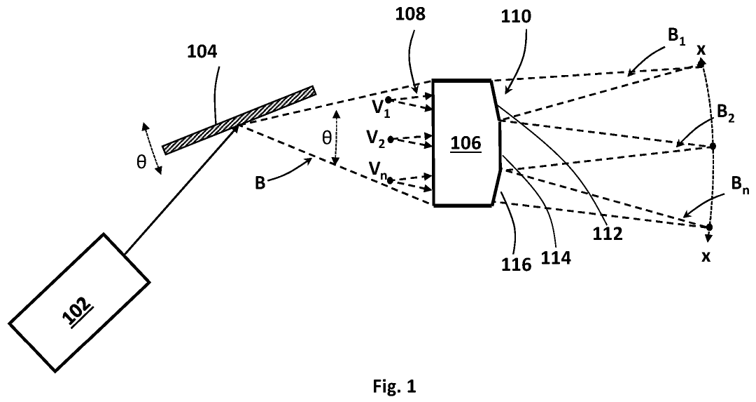

A scanning projector system 100 according to an embodiment is illustrated schematically in FIG. 1. In overview, the scanning projector system 100 comprises: a light source 102; at least one scanning mirror 104; and an optical splitter 106. The light source 102 may be any suitable light source, and by way of example, may comprise an array of low power RGB (red, green, blue) light sources such as laser diodes or LEDs to generate a collimated light beam. The collimated beam may have a beam diameter of, for example, approximately 1 mm and the reflective surface area of the at least one scanning mirror 104 may be sized accordingly. The light source 102 is arranged at an input side of the scanning mirror 104 and directs the light beam onto the scanning mirror 104. The optical splitter 106 may be arranged at an output side of the scanning mirror 104 to receive the light beam as reflected by the scanning mirror 104. The at least one scanning mirror 104 may be a two-dimensional scanning mirror, also known as a tip-tilt mirror. Alternatively, there may be two one-dimensional scanning mirrors, where one scanning mirror scans in the horizontal direction and the other scanning mirror scans in the vertical direction. The scanning mirror(s) may be any appropriate micro electrical mechanical (MEMS) mirror. For simplicity and ease of explanation the embodiments described herein refer to a two-dimensional type scanning mirror and the skilled person will appreciate that the inventive concept(s) according to the present disclosure is (are) equally applicable. The optical splitter 106 is arranged at the output of the scanning mirror 104 to receive light beam B (or input optical signal) from the light source 102 via the scanning mirror 104.

The optical splitter 106 is an optically transparent structure which receives an input light beam B, from the light source 102 at an input side 108 and refracts the input light beam B to a plurality of output beamlets B₁, B₂, Bₙ (or output optical signals). The optical splitter may be formed of spaced apart optically transparent structure, having an air gap therebetween, or different and discrete adjoining optical structures.

The scanning mirror 104 is arranged to rotate through a range of angular rotation 0, between a maximum and minimum angular position and this range is known as the mechanical deflection range of the scanning mirror. For example, the total range of angular rotation may be 30 degrees. In the illustrated example the range of angular rotation is in the horizontal plane, however the present discussion is also relevant in the vertical plane. Where the scanning mirror 104 is a plane mirror surface it follows therefore that the maximum optical reflection angle is two times mechanical deflection range angle which defines a projection plane range of the scanning mirror 104. The input light beam B may therefore be scanned over the projection plane range of the scanning mirror 104.

The input side 108 of the optical splitter 106 is arranged to receive the input light beam B from the scanning mirror 104 over the projection plane range and the optical splitter 106 refracts the input light beam B into a plurality of output beamlets B₁, B₂, Bₙ which exit the optical splitter 106 from the output side 110. In this way, the optical splitter is positioned in the optical path of the scanning mirror. The output side 110 of the optical splitter 106 comprises a plurality of optical facets 112, 114, 116 to provide the plurality of output beamlets B₁, B₂, Bₙ. Whilst the example illustrated shows three optical facets 112, 114, 116 which divert the input light beam B into respective output beamlets B₁, B₂, Bₙ the number of optical facets may be any positive integer n which divert the input beam B into a corresponding integer n of output beamlets depending on the input angle of the input beam.

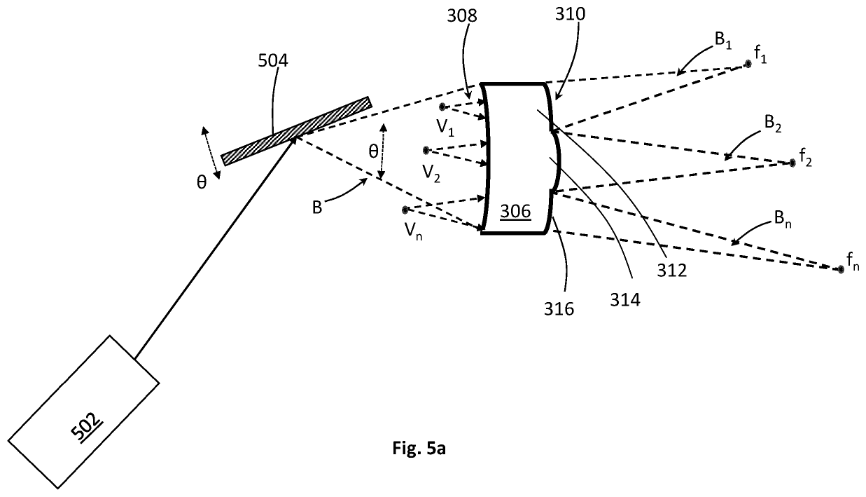

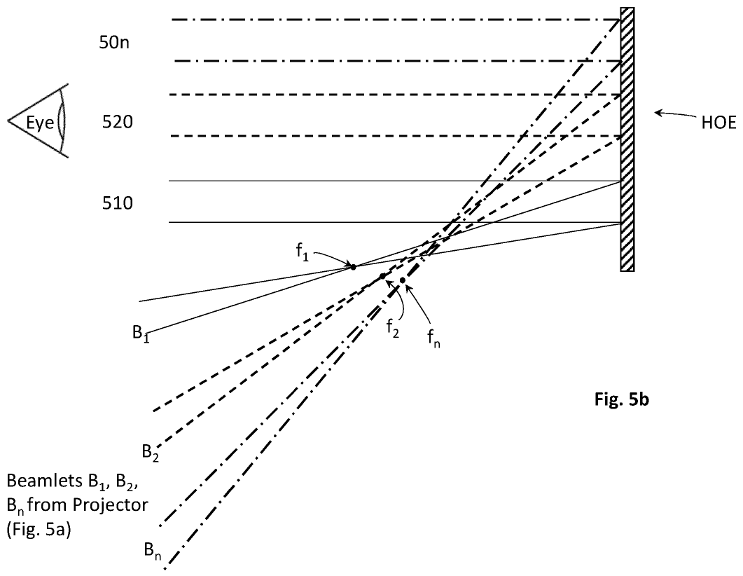

The eyebox of scanning projector systems, such as the scanning projector system 100 described above is given by the geometry of the exit pupil exiting the projector. It is well established that such scanning projector systems utilise a small exit pupil, which may typically have an area of between 1 mm² and 0.5 mm². In order to increase the size of the eyebox the projector system 100 according to embodiments utilises exit pupil replication to increase the number of eyeboxes visible to the user, rather than increasing the size of a single eyebox. This has the advantage that when a user's gaze is taken from a central eyebox position, by movement of the user's eye away from the central position, another repeated and spatially separated eyebox will be visible to the user when their gaze is off center. This concept is described with reference to FIG. 5b below. The number of replicated exit pupils, and thus the number of spatially separated eyeboxes, corresponds to the number of output beamlets Bₙ and therefore the number of optical facets on the output side 110 of the beam splitter 106.

Geometrically, each of the output beamlets B₁, B₂, Bₙ, appear to originate from spatially separated virtual projector positions V₁, V₂, Vₙ. Specifically, the optical splitter 106 splits or replicates the input beam B into respective beamlets B₁, B₂, Bₙ so that the output beamlet B₁ effectively originates from virtual projector position V₁. Output beamlet B₂ effectively originates from virtual projector position V₂ and output beamlet Vₙ would effectively originate from virtual projector position Vₙ. The specific beamlet will be dependent on the angle of the input beam B as scanned by the scanning mirror 104. In other words, the virtual projector positions V₁, V₂, Vₙ define optical paths of the respective beamlets B₁, B₂, Bₙ. Each of the beamlets B₁, B₂, Bₙ are focused on an intermediate focal surface x-x.

When in use, the optical splitter 106 receives the input light beam B at the input side 108. The light beam B can be scanned over a total angular range θ by the scanning mirror 104 and corresponds to the range of available angles that the light beam B may be incident on the input side of the optical splitter 106. Based on the angle of incidence of the light beam B (as subset of the total angular range θ) the output beamlet from the optical spitter will be one of B₁, B₂, Bₙ. As the scanning mirror 104 scans over the range θ one of each of beamlets B₁, B₂, Bₙ will progressively exit the respective output facet of the optical splitter 106. In this way the optical splitter 106 replicates one eyebox at a time based on the scan angle of the scanning mirror 104. The skilled person will understand the scanning mirror scans across a horizontal plane (the plane of the page as illustrated in FIG. 1) of the input side 108 of the optical splitter 106. Where the scanning mirror 104 is a two-dimensional scanning mirror and the optical splitter comprises a two-dimensional array of facets, the scanning mirror will be arranged to scan in the horizontal direction as mentioned and in the vertical dimension (normal to the plane of the page as illustrated in FIG. 1).

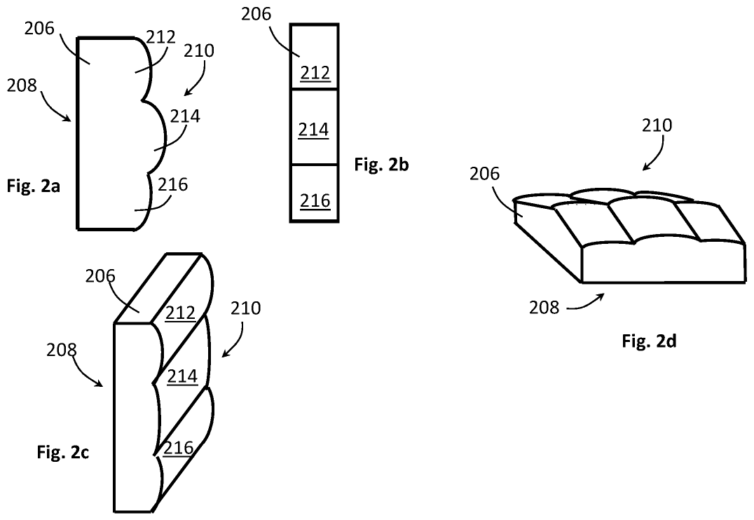

FIGS. 2a, 2b, 2c and 2d illustrate schematic views of an optical splitter 206 according to embodiments. In overview, the optical splitter 206 has a generally volumetric polygonal structure with an input side and an opposing output side, where the input side 208 comprises at least one optical facet and output side 210 comprises two or more adjacent optical output facets 212, 214, 216 making up the sides of the polygonal structure. For the embodiment of FIGS. 2a to 2c, the input side 208 of the optical splitter 206 comprises a single planar input facet arranged to receive an input light beam over a range of angular rotation e from the scanning mirror to in-couple the input light beam into the optical splitter 206.

The output side 210 of the optical splitter 206 comprises a plurality of output optical facets 212, 214, 216 arranged to out-couple a corresponding plurality of beamlets B₁, B₂, Bₙ, split from the input light beam, from the optical splitter 206. In the example of FIGS. 2a to 2c, there are three output facets 212, 214, 216 arranged as a linear array. However, the skilled person will appreciate that there may be any number of output facets and they may be arranged as a two-dimensional n×m array (where n and m are positive integers, where n=1 and m>2) or a circular array. The number of output facets can be chosen dependent on the number and geometrical arrangement of replicated eye boxes required by a specific application. Each of the output optical facets defines a corresponding virtual projector position V₁, V₂, Vₙ as discussed above and thus a corresponding optical path through the optical splitter.

Two or more of the output optical facets 212, 214, 216 may introduce or add optical power and in this regard each of the output optical facets 212, 214, 216 may have a curved surface to provide the optical power. The arrangement of curved output facets 212, 214, 216 introduces optical power into the optical paths defined by the corresponding number of virtual projector positions V₁, V₂, Vₙ. The optical power of adjoining optical facets will be different and this difference may result in increasing optical power from one output optical facet to an adjacent output optical facet. Conversely, taking the same optical facet as a starting point, the difference may result in decreasing optical power from one optical facet to the next.

Specifically, the optical power may increase from the first output optical facet 212 to the second output optical facet 214 and be a maximum at the third output optical facet 216. Taking the converse case, the optical power may decrease from the first output optical facet 212 to the second optical facet 214 and be minimum at the third optical facet 216. By way of non-limiting example in the increasing case, the optical power of the first output optical facet may be +10 dioptres (m⁻¹), the optical power of the second output optical facet may be +30 dioptres (m⁻¹) and the optical power of the third output optical facet may be +100 dioptres (m⁻¹). By way of non-limiting example in the decreasing case, the optical power of the first optical facet may be +100 dioptres (m⁻¹), the optical power of the second optical facet may be +30 dioptres (m⁻¹) and the optical power of the third optical facet may be +10 dioptres (m⁻¹). Whilst the forgoing example uses a positive sign for the optical power, thus indicating a positive or convex curved optical facet surface (when considered from the direction of light propagating through the optical splitter), the skilled person will appreciate a negative sign for optical power would also be appropriate, which would indicate a negative or concave curved optical facet surface (again when considered from the direction of light propagating through the optical splitter).

Furthermore, the variation in optical power can be such that the amount of power for a beamlet can be positive or negative depending on the input beam, and dependent on the specific nature of the application (such as augmented reality smart glasses) the differential power that needs to be added/subtracted to the other beamlets. Indeed, the skilled person will appreciate that any combination of convex or concave curved or even planar optical facet surfaces may be combined to provide the difference in optical power, for example, +40, +0, −40 dioptres. The examples arrangement and examples given here also apply output optical facets arranged as a two-dimensional array, that is, where there is an optical power difference between adjoining output optical facets.

In AR applications involving a holographic optical element, the skilled person will appreciate that more positive focusing power is required to bring the intermediate focal surface x-x closer to the optical splitter and thus away from the holographic optical element. Whereas more negative optical power is required to bring the intermediate focal surface x-x closer to the holographic optical element and thus away from the optical splitter. By appropriate selection of the optical power difference, it is possible to match the position of the intermediate focal plane with respect to the position of the holographic optical element and thus the eyebox geometry, that is spacing of replicated pupils within the eyebox (as illustrated in FIG. 5b).

To achieve the difference in optical power each output optical facet may have a different radius of curvature. Optionally, each facet may have different center of curvature (in other words tilt of the facet) relative to the incoming beam and or each of the facets may have both different radii of curvature and different center of curvature. Radius of curvature in this case is given by the distance from the vertex of the curve of the respective facet to the center of curvature, where the vertex is the located on the optical axis of that facet. The foregoing assumes a constant refractive index across the optical splitter. Indeed, the each of the facets may be shaped elliptically or they may have freeform curvatures allowing for further aberration control. Optionally, and as opposed to different radii or centers of curvature it may be possible to introduce the required optical power difference by introducing a refractive index difference across the optical splitter. This refractive index difference may a be graded refractive index. Specifically, the refractive index of the optical splitter material may be different corresponding to each of the virtual projector positions V₁, V₂, Vₙ, and this may provide for a difference of optical power for each of the beamlets originating from corresponding to virtual projector positions V₁, V₂, Vₙ.

FIGS. 2b and 2c illustrate end view and perspective views respectively, of the output side 210 of an optical splitter according to an example embodiment. In this example the output side 210 is formed of three facets 212, 214, 216 arranged as a 1×3 array. The skilled person will appreciate that any number of facets may be provided on the output side 210 depending on the required number and positioning of pupil replications required. For example, and as illustrated in the perspective view of FIG. 2d, if six pupil replications are required, the output side 210 of the optical splitter 206 may be arranged as a 2×3 array of output facets. The skilled person will appreciate therefore that the output optical facets may be arranged as a two-dimensional n×m array, where n and m are positive integers and n>2 and m>2.

In the case of the 1×3 array illustrated in FIGS. 2a to 2c, each of the facets may include an edge or vertex that is connected to a respective vertex which is joined to a respective vertex on an adjoining facet. In the example embodiment, one vertex of facet 212 will adjoin a first vertex of facet 214. A second vertex of facet 214 will adjoin a vertex of facet 216 and this concept can be extended for any number of facets, such as the 2×3 example of FIG. 2d. In this regard the vertices may not be hard lines/boundaries (which can be particularly the case where the radii of curvature of adjoining facets is similar, but not identical, or where the center of curvature is similar but not identical) but may merely define outer edges of the output facets, on the output side, defining the intersection between facets providing separate and distinct pupil replications. In this regard, the skilled person will appreciate that each of the facets provide for separate and distinct eye-boxes (dependent on the angle of incidence of the input beam B on the input side of the optical splitter as discussed above).

Furthermore, looking at the optical splitter illustrated in FIG. 2a, whilst the individual output side facets 212, 214, 216 may be concave, the overall shape of the output surface 210 may also be generally concave in outline. In an alternative arrangement the overall shape of the output surface may be generally convex in outline, whilst still retaining individually concave shaped facets 212, 214, 216. The opposite is also true, in that the individual facets 212, 214, 216 may be convex and the overall shape of the output surface 210 may also be convex or concave in outline. Moreover, the individual output facets 212, 214, 216 may be a combination of concave, convex and/or planar and the overall shape of the output surface 210 may also be convex or concave in outline regardless of the individual curvatures of the output facets.

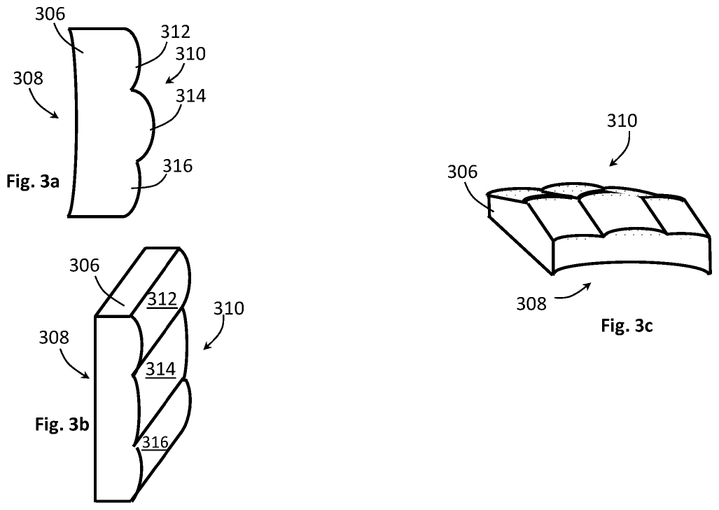

FIGS. 3a and 3b, illustrate schematic views of an optical splitter 306 according to an embodiment. In overview, the optical splitter 306 has a generally volumetric polygonal structure with an input side and an output side where the input side 308 and output side 310 have a generally faceted structure making up the sides of the polygonal structure. The output side 310 may be configured consistent with the arrangement of FIGS. 2a to 2c or the arrangement of FIG. 2d as described above. Unlike the arrangement of FIGS. 2a to 2c, for the arrangement of FIGS. 3a and 3b the input side 308 comprises a curved input facet arranged to receive an input light beam over the range of angular rotation 0 from the scanning mirror to in-couple the input light beam into the optical splitter 306. The input side may be circularly curved, elliptically curved or freeform curved and may be concave or convex to provide optical power. As with the arrangement of FIG. 2d described above, the output optical facets of output side 310 maybe arranged as a two-dimensional n×m array as illustrated in FIG. 3c.

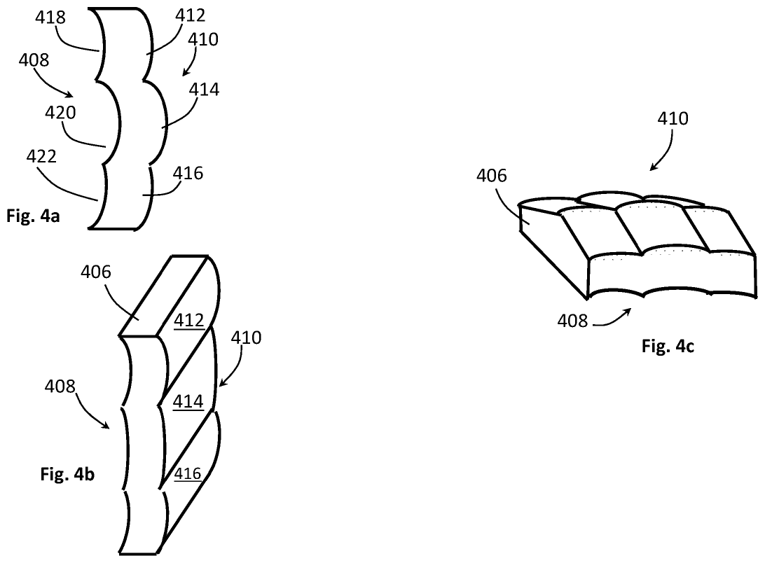

FIGS. 4a and 4b, illustrate schematic views of an optical splitter 406 according to an embodiment. In overview, the optical splitter 406 has a generally volumetric polygonal structure with an input side and an output side where the input side 408 and 410 have a generally faceted structure making up the sides of the polygonal structure. The output side 410 may be configured consistent with the arrangement of FIGS. 2a to 2c as described above. Unlike the arrangement of FIGS. 2a to 2c, for the embodiment of FIGS. 4a and 4b the input side 408 can comprise a plurality of curved input facets 418, 420, 422 arranged to receive an input light beam over the range of angular rotation 0 from the scanning mirror to in-couple the input light beam into the optical splitter 406. The input facets may be arranged as an n×m array, where n and m are positive integers and n=1 and m>2, or n>1 and m>2. Each of the input facets may be circularly curved, elliptically curved or freeform curved. The skilled person will appreciate that the input facets may be arranged in a similar manner to the facets of the output side 410, in that they may be arranged as an array of facets and each of the facets may have optical power and the facets may be individually concave or convex so that they each have a different optical power. The input surface may define an overall outline convex or concave geometry, regardless of the individual curvatures of the facets input facets 418, 420, 422. As with the arrangement of FIGS. 2d and 3b described above, the output optical facets of output side 410 maybe arranged as a two-dimensional n×m array as illustrated in FIG. 4c.

Following the above discussion therefore, the input side and output side optical facets can be considered to be thin, close together cooperating lens surfaces such that optical power of cooperating lens surfaces is equal to the sum of the optical powers of each surface. Input optical facets and output optical facets can be considered cooperating when they share an optical path defined by a virtual projector position. More specifically, and with regard to the embodiment of FIGS. 3a to 3c, having a curved input side, the total optical power P_{Total} associated with each of the output side facets 312, 314, 316 will be equal to the sum of the optical power of each individual output side facets Pₒᵤₜ and the optical power Pᵢₙ of the curved input side. In other words, and taking the example of FIG. 1, the optical power associated with virtual projector V₁ and beamlet B₁ will be equal to the optical power of the input side 108 and the output facet 112. This is also true for the optical power associated with virtual projector V₂ and beamlet B₂ for output facet 114 and so on for each respective virtual projector Vₙ, beamlet Bₙ related to a specific output facet. Similarly, with regard to the embodiment of FIGS. 4a to 4c having a curved faceted input side, the total optical power P_{Total} associated with each of the output side facets 412, 414, 416 will be equal to the sum of the optical power of each individual output side facets Pₒᵤₜ and the optical power Pᵢₙ of each of the input side facets 418, 420, 422. In other words, and taking the example of FIG. 1, the optical power associated with virtual projector V₁ and beamlet B₁ will be equal to the optical power of the input side facet and the respective output facet. This is also true for the optical power associated with virtual projector V₂ and beamlet B₂ each respective pair of input side facet and output facet and so on for each respective virtual projector Vₙ, beamlet Bₙ related to a specific pair of input and output side facets.

The optical splitter 106, 206, 306, 406, according to embodiments may be formed of any appropriate optical material such as optical glass (e g. BK-7), acrylic or fluorite. The maximum thickness of the optical splitter (from input side to output side) will be in the region of a few millimetres (mm) and typically 2-10 mm, and preferably about 3-5 mm. The optical splitter may have an air gap between the input side and the output side. The optical splitter may be formed of a combination of optical materials, where the input side if formed of one material and the output side is formed of another material. Similarly, the input side may be formed of the same material as the output side, but they may have different refractive indices.

The introduction of optical power in the optical splitters, as described herein, provides for a uniform image quality among eye boxes and thus improved resolution because replicated pupils originate from a set of displaced positions (e.g. virtual projector positions) which are optimally focused at a user's eye. Additionally, such optical power may be chosen to correct for eye box specific aberrations, again improving resolution. These improvements can be achieved without the need for liquid lenses and the associated problems.

An optical splitter 206, 306, 406 of the types described above with respect to FIGS. 2a to 2d, FIGS. 3a to 3c, and FIGS. 4a to 4c may be included in a scanning projector system of the type illustrated in FIG. 1. FIG. 5a illustrates a scanning projector system utilising an optical splitter 306 of the type described above with respect to FIGS. 3a and 3b. The skilled person will appreciate that any of the optical splitters described herein may be utilised depending on the specific circumstances of the application and consistent with the inventive concept described. In the case of two-dimensional arrays of input and/or output facets that is greater than two facets in each direction of the array (3×3 for example), the scanning mirror can be a two-dimensional scanning mirror. The number of facets on the input side can be equal to the number of optical facets on the output side. Conversely, the number of facets on the input side may not be equal to the number of optical facets on the output side.

As with the arrangement of FIG. 1, light from the light source 502 is reflected on to the input side 308 of the optical splitter 306 by the scanning mirror 504. The output side 310 of the optical splitter 306, comprising a plurality of output facets 312, 314, 316 is arranged to out-couple a corresponding plurality of output beamlets B₁, B₂, Bₙ, from the input light beam B. The optical splitter 306 will out-couple one of the output beamlets B₁, B₂, Bₙ dependent on the angle of incidence of the input beam B at the input side of the optical splitter 306 and this is illustrated with regard to the virtual projector positions V₁, V₂, Vₙ. Specifically, when the scanning mirror 504 is at first angle, corresponding to virtual projector position V₁, the output beamlet B₁ will emerge from the optical facet 312 of the output side 310 of the optical splitter 306. Likewise, when the scanning mirror 504 is at subsequent angles corresponding to virtual projector position V₂ or Vₙ output beamlet B₂ or Bₙ will emerge from the optical facet 314 or 316 output side 310 of the optical splitter 306 dependent on the angle of the input beam B. Output beamlet B₁ will be focused at an intermediate focal point f₁ due to the optical power associated with the input side and output side facet 312. Similarly, output beamlet B₂ will be focused at an intermediate focal point f₂ due to the optical power associated with the input side and output side facet 314. Moreover, output beamlet Bₙ will be focused at an intermediate focal point fₙ due to the optical power associated with the input side and output side facet 316. The focal length f₁ of beamlet B₁ emerging from output side facet 310 may be less than the focal length f₂ of beamlet B₂ emerging from output side facet 312. The focal length f₂ of beamlet B₂ emerging from output side facet 312 may be less than the focal length fₙ of beamlet Bₙ emerging from output side facet 314. In other words, f₁<f₂<fₙ. Alternatively, and depending on the specific application, the focal length f₁ of beamlet B₁ emerging from output side facet 310 may be greater than the focal length f₂ of beamlet B₂ emerging from output side facet 312. The focal length f₂ of beamlet B₂ emerging from output side facet 312 may be greater than the focal length fₙ of beamlet Bₙ emerging from output side facet 314. In other words, f₁>f₂>fₙ. In this way the focal length will either monotonically increase or monotonically decrease from one facet to the next.

Following the examples given above, where the optical power of the first output optical facet may be +10 dioptres, the optical power of the second output optical facet may be +30 dioptres and the optical power of the third output optical facet may be +100 dioptres, the corresponding focal lengths will be 10 mm, 30 mm and 100 mm respectively (noting that FIG. 5a is not drawn to scale). Dependent on the incident input beam the respective output beams therefore experience a net power difference the result of which can be to shift focal points of the intermediate focal surface by an amount dependent on the power experienced by the beamlet through one of the output optical facets. In this way, the optical splitter can be optimised for a specific holographic optical element design and eyebox replication geometry without the need for additional optics such as liquid lenses. For example, without optical power one of the beamlets may have a focal length of 40 mm (from the holographic optical element). With a 4 dioptre a focal shift of roughly 5 mm may be achieved.

The skilled person will see therefore that it is possible to modify the focal length of specific beamlets dependent on the angle of incidence of the input beam on the optical splitter due to the optical power introduced by the combination of the input side optical power (which taking the arrangement of FIGS. 2a to 2d may be zero) and the optical powers of the output side facets. In doing, so the collimation of the beamlets is improved for each of the eye boxes without need for liquid lenes. This has distinct advantages over known solutions, such as liquid lenses, because it does not require expensive and complicated control electronics to modulate the focal length of the liquid lens dependent on the angle of the beamlet incident thereon.

The scanning projector systems of the type described above with respect to FIGS. 1 and 5a comprising an optical splitter according to embodiments, may be utilised in augmented reality (AR) systems, such as smart glasses, head mounted displays, head up displays and the like. AR systems are well known in the art and typically comprise a scanning projector system, which when in use projects images onto to holographic optical element (HOE) from which the images are relayed to a user's eye. The HOE may be arranged in, or on, a lens of the AR system, and the lens may be mounted on a frame, such as a glasses frame. The frame can also provide support for the projector system which can be mounted or housed on the frame, such as the arm of a glasses frame. The projector can be aligned with respect to the lens comprising the HOE to direct images to a user's eye.

A schematic illustrating the output beamlets B₁, B₂, Bₙ, from a projector system according to embodiments, incident on a holographic optical element HOE is shown in FIG. 5b (as with FIG. 5a this is not drawn to scale). Spatially separated exit pupils 510, 520 and 50n are projected at a user's eye dependent on the input angle of the input light beam B from the light source 502 and scanning mirror 504 illustrated in FIG. 5a. When the scanning mirror 504 is at a position corresponding to virtual projector point V₁, beamlet B₁ exits the optical splitter from facet 310 and is focused on a focal point f₁. Beamlet B₁ is then incident on the holographic optical element (HOE) and directed to exit pupil position 510. Similarly, when the scanning mirror 504 is at a position corresponding to virtual projector point V₂, beamlet B₂ exits the optical splitter from facet 312 and is focused on a focal point f₂. Beamlet B₂ is then incident on the holographic optical element (HOE) and directed to exit pupil position 520. Likewise, when the scanning mirror 504 is at a position corresponding to virtual projector point Vₙ, beamlet Bₙ exits the optical splitter from facet 314 and is focused on a focal point f₃. Beamlet Bₙ is then incident on the holographic optical element (HOE) and directed to exit pupil position 50n. Due to the different optical powers experienced by each of beamlets they will be focused at different lengths from the optical splitter. In other words, each of the output facets of the optical splitter has a different focal length. In this way, based on the input angle of the input light beam B it is possible to achieve pupil replication at the eye of the user without loss of image resolution and without the need for additional optical elements such as liquid lenses and the attendant problems associated therewith.

It should be noted that the curvatures of the optical facets as illustrated in the appended figures have been exaggerated for illustration purposes and no dimensions (unless stated in the text or drawings) should be inferred.

Particular and preferred aspects of the disclosure are set out in the accompanying independent claims. Combinations of features from the dependent and/or independent claims may be combined as appropriate and not merely as set out in the claims.

The scope of the present disclosure includes any novel feature or combination of features disclosed therein either explicitly or implicitly or any generalisation thereof irrespective of whether or not it relates to the claimed disclosure or mitigate against any or all of the problems addressed by the present disclosure. The applicant hereby gives notice that new claims may be formulated to such features during prosecution of this application or of any such further application derived therefrom. In particular, with reference to the appended claims, features from dependent claims may be combined with those of the independent claims and features from respective independent claims may be combined in any appropriate manner and not merely in specific combinations enumerated in the claims.

Features which are described in the context of separate embodiments may also be provided in combination in a single embodiment. Conversely, various features which are, for brevity, described in the context of a single embodiment, may also be provided separately or in any suitable sub combination.

The term “comprising” does not exclude other elements or steps, the term “a” or “an” does not exclude a plurality. Reference signs in the claims shall not be construed as limiting the scope of the claims.

1. An optical splitter for a scanning projector system, the optical splitter comprising: an input side and a spaced apart and opposing output side, wherein the input side comprises at least one input optical facet and the output side comprises two or more output optical facets;
wherein the at least one input optical facet is arranged to receive an input optical signal from a light source;
wherein the two or more output optical facets are arranged to output an output optical signal dependent on the input optical signal;
wherein each of the output optical facets define an optical path; and
wherein each of the optical paths have a different optical power.

2. The optical splitter of claim 1, wherein the two or more output optical facets each have a respective optical power and the optical power of each of the at least two or more of the respective output optical facets is different.

3. The optical splitter of claim 1, wherein the output optical facets are arranged as a one-dimensional array.

4. The optical splitter of claim 1, wherein the output optical facets are arranged as a two-dimensional array.

5. The optical splitter of claim 1, wherein the optical power of each of the at least two or more of the respective output optical facets are defined by a respective radius of curvature of each of the output optical facets and each radius of curvature is different.

6. The optical splitter of claim 1, wherein the optical power of each of the at least two or more of the respective output optical facets are defined by a radius of curvature of each of the output optical facets and each of the output optical facets have a different center of curvature.

7. The optical splitter of claim 5, wherein the curvature of the output optical facets is concave and/or convex.

8. The optical splitter of claim 1, wherein the input side comprises two or more input optical facets.

9. The optical splitter of claim 8, wherein the two or more input optical facets each have a respective optical power.

10. The optical splitter of claim 9, wherein the optical power of each of the at least two or more of the input optical facets is different.

11. The optical splitter of claim 8, wherein the input optical facets are arranged as a one-dimensional array.

12. The optical splitter of claim 8, wherein the input optical facets are arranged as a two-dimensional array.

13. The optical splitter of claim 8, wherein the optical power of each of the at least two or more of the respective input optical facets is defined by a respective radius of curvature of each of the input optical facets and each radius of curvature is different.

14. The optical splitter of claim 8, wherein the optical power of each of the at least two or more of the respective input optical facets is defined by a respective radius of curvature of each of the input optical facets and each of the input optical facets have a different center of curvature.

15. The optical splitter of claim 1, further comprising a volumetric polygonal transparent structure.

16. The optical splitter of claim 1, wherein each of the output optical facets have a different focal length.

17. A scanning projector system for a virtual retinal display, the scanning projector system comprising: a light source to provide an input optical signal, a scanning mirror arranged to reflectively scan the input optical signal from the light source and an optical splitter according to claim 1, wherein the optical splitter is positioned in an optical path of the scanning mirror and the scanning mirror is arranged rotate between a first angular position and a second angular position.

18. The scanning projector system of claim 17, wherein the input side of optical splitter is arranged to receive the input optical signal reflectively scanned by the scanning mirror, and wherein the output side of the optical splitter is arranged to output an output optical signal from one of the output optical facets dependent on the angular position of the input optical signal.

19. (canceled)

20. A virtual retinal display comprising: the scanning projector system of claim 17, and a holographic optical element, wherein the scanning projector system is arranged to project a plurality of exit pupils onto the holographic optical element and the holographic optical element is arranged to direct the plurality of exit pupils to an eye of a user.

21. A pair of augmented reality glasses comprising the virtual retinal display of claim 20, wherein the holographic optical element is arranged in or on a lens of the glasses.
